(19) United States
(12) Patent Application Publication
(10) Pub. No.: US 2023/0324560 A1
(43) Pub. Date: Oct. 12, 2023

(54) ASSISTED GLOBAL NAVIGATION SATELLITE SYSTEM ALGORITHM ENHANCEMENT WHEN NO SERVING CELL IS FOUND

(71) Applicant: Telefonaktiebolaget LM Ericsson (publ), Stockholm (SE)

(72) Inventor: Kai WANG, Milton (CA)

(21) Appl. No.: 18/042,006

(22) PCT Filed: Aug. 21, 2020
(86) PCT No.: PCT/IB2020/057875

§ 371 Date: Feb. 17, 2023

(51) Int. Cl. G01S 19/06

(52) U.S. Cl. CPC G01S 19/06

(57) ABSTRACT

Apparatus and methods related to positioning services. In one embodiment, a wireless device (22a, 22b) sends a request assistance data message comprising at least one neighbor cell identification, ID, to a location management network node (14); and receive a provide assistance data message comprising assistance data, the assistance data including satellite measurement information for the wireless device and the satellite measurement information being based at least in part on the at least one neighbor cell ID. In one embodiment, a location management network node (14) is configured to receive a request assistance data message comprising at least one neighbor cell ID from a wireless device (22a, 22b); and send a provide assistance data message comprising assistance data, the assistance data including satellite measurement information for the wireless device (22a, 22b) and the satellite measurement information being based at least in part on the at least one neighbor cell ID.

### TECHNICAL FIELD

The present disclosure relates to wireless communications and, in particular, to location based services.

### BACKGROUND

The Location Management Function (LMF) deployed in the 3^{rd} Generation Partnership Project (3GPP) 5^{th} Generation (5G, also called New Radio or NR) core (5GC) network supports control plane positioning for subscribers in the New Radio (NR) network.

The Assisted Global Navigation Satellite System (A-GNSS) method uses satellite signal measurements retrieved by systems such as Global Positioning System (GPS) and Global Orbiting Navigation Satellite System (GLONASS). This method is considered a highly accurate positioning procedure where the location server, such as the location management function (LMF), sends assistance data and enhances positioning performance by shortening the Time To First Fix (TTFF), thereby increasing receiver sensitivity, reducing power consumption, and increasing the accuracy of location calculation.

The LMF supports both wireless device (WD) assisted (WD-assisted) A-GNSS and WD-based A-GNSS positioning methods using GPS, GLONASS, or both satellite systems. Autonomous GNSS is supported as a fallback for WD-based AGNSS and WD-assisted A-GNSS.

If the LMF selects A-GNSS, it generates the A-GNSS assistance data based on the reference location derived from the serving NR cell identifier (CID). The LMF then sends the A-GNSS assistance data to the target WD in a Location Positioning Protocol (LPP) ProvideAssistanceData message. However, such existing positioning arrangements have drawbacks that may result in a positioning failure.

### SUMMARY

Some embodiments advantageously provide a method and system related to location based services.

According to one aspect of the present disclosure, a method implemented in a wireless device, WD, is provided. The method includes sending a request assistance data message comprising at least one neighbor cell identification, ID, to a location management network node; and receiving a provide assistance data message comprising assistance data, the assistance data including satellite measurement information for the wireless device and the satellite measurement information being based at least in part on the at least one neighbor cell ID.

In some embodiments of this aspect, the satellite measurement information is based at least in part on a neighbor cell location, the neighbor cell location being determined using the at least one neighbor cell ID comprised in the request assistance data message. In some embodiments of this aspect, the request assistance data message comprises a list of neighbor cell IDs, and a sequence of the neighbor cell IDs in the list being determined by a signal strength of each neighbor cell indicated by the respective neighbor cell ID.

In some embodiments of this aspect, the satellite measurement information is based at least in part on a selection of a single neighbor cell ID from the list having a highest signal strength in the list that is also included in a database associated with the location management network node. In some embodiments of this aspect, the method further includes receiving a second provide assistance data message comprising a second assistance data; and determining that the second assistance data is incorrect. In some embodiments of this aspect, sending the request assistance data message comprising the at least one neighbor cell ID is a result of the determination that the second assistance data is incorrect.

In some embodiments of this aspect, the request assistance data message further comprises a primary cell identification, ID, in addition the at least one neighbor cell ID, the primary cell ID being different from each of the at least one neighbor cell ID. In some embodiments of this aspect, each of the request assistance data message and the provide assistance data message is a Third Generation Partnership Project, 3GPP, Long Term Evolution, LTE, positioning protocol, LPP, message. In some embodiments of this aspect, the at least one neighbor cell ID is comprised in a common information elements, IEs, request assistance data IE. In some embodiments of this aspect, the request assistance data message comprising the at least one neighbor cell ID is a request for the location management network node to send periodic assistance data to the wireless device. In some embodiments of this aspect, the location management network node includes a location management function, LMF.

According to yet another aspect of the present disclosure, a method implemented in a location management network node is provided. The method includes receiving a request assistance data message comprising at least one neighbor cell identification, ID, from a wireless device; and sending a provide assistance data message comprising assistance data, the assistance data including satellite measurement information for the wireless device and the satellite measurement information being based at least in part on the at least one neighbor cell ID.

In some embodiments of this aspect, the method further includes determining a neighbor cell location using the at least one neighbor cell ID comprised in the request assistance data message; and the satellite measurement information is based at least in part on the neighbor cell location. In some embodiments of this aspect, the request assistance data message comprises a list of neighbor cell IDs and a sequence of the neighbor cell IDs in the list being based on a signal strength of each neighbor cell indicated by the respective neighbor cell ID. In some embodiments of this aspect, the method further includes selecting a single neighbor cell ID from the list having a highest signal strength in the list that is also included in a database associated with the location management network node; and the satellite measurement information is based at least in part on the selected neighbor cell ID.

In some embodiments of this aspect, the method further includes sending a second provide assistance data message comprising a second assistance data; and receiving the request assistance data message comprising the at least one neighbor cell ID is a result of the second assistance data being incorrect. In some embodiments of this aspect, the request assistance data message further comprises a primary cell identification, ID, in addition to the at least one neighbor cell ID, the primary cell ID being different from each of the at least one neighbor cell ID. In some embodiments of this aspect, each of the request assistance data message and the provide assistance data message is a Third Generation Partnership Project, 3GPP, Long Term Evolution, LTE, positioning protocol, LPP, message.

In some embodiments of this aspect, the at least one neighbor cell ID is comprised in a common information elements, IEs, request assistance data IE. In some embodiments of this aspect, the request assistance data message comprising the at least one neighbor cell ID is a request for the location management network node to send periodic assistance data to the wireless device. In some embodiments of this aspect, the location management network node includes a location management function, LMF.

According to another aspect of the present disclosure, a wireless device, WD, configured to communicate with a network node is provided. The wireless device includes processing circuitry. The processing circuitry is configured to cause the wireless device to send a request assistance data message comprising at least one neighbor cell identification, ID, to a location management network node; and receive a provide assistance data message comprising assistance data, the assistance data including satellite measurement information for the wireless device and the satellite measurement information being based at least in part on the at least one neighbor cell ID.

In some embodiments of this aspect, the satellite measurement information for the wireless device that is based at least in part on a neighbor cell location, the neighbor cell location being determined using the at least one neighbor cell ID comprised in the request assistance data message. In some embodiments of this aspect, the request assistance data message comprises a list of neighbor cell IDs, and a sequence of the neighbor cell IDs in the list being determined by a signal strength of each neighbor cell indicated by the respective neighbor cell ID. In some embodiments of this aspect, the satellite measurement information is based at least in part on a selection of a single neighbor cell ID from the list having a highest signal strength in the list that is also included in a database associated with the location management network node.

In some embodiments of this aspect, the processing circuitry is further configured to cause the wireless device to receive a second provide assistance data message comprising a second assistance data; and determine that the second assistance data is incorrect; and the processing circuitry is configured to cause the wireless device to send the request assistance data message comprising the at least one neighbor cell ID as a result of the determination that the second assistance data is incorrect. In some embodiments of this aspect, the request assistance data message further comprises a primary cell identification, ID, in addition the at least one neighbor cell ID, the primary cell ID being different from each of the at least one neighbor cell ID.

In some embodiments of this aspect, each of the request assistance data message and the provide assistance data message is a Third Generation Partnership Project, 3GPP, Long Term Evolution, LTE, positioning protocol, LPP, message. In some embodiments of this aspect, the at least one neighbor cell ID is comprised in a common information elements, IEs, request assistance data IE. In some embodiments of this aspect, the request assistance data message comprising the at least one neighbor cell ID is a request for the location management network node to send periodic assistance data to the wireless device. In some embodiments of this aspect, the location management network node includes a location management function, LMF.

According to another aspect of the present disclosure, a location management network node configured to communicate with a wireless device is provided. The location management network node includes processing circuitry. The processing circuitry is configured to cause the location management network node to receive a request assistance data message comprising at least one neighbor cell identification, ID, from a wireless device; and send a provide assistance data message comprising assistance data, the assistance data including satellite measurement information for the wireless device and the satellite measurement information being based at least in part on the at least one neighbor cell ID.

In some embodiments of this aspect, the processing circuitry is configured to cause the location management network node to determine a neighbor cell location using the at least one neighbor cell ID comprised in the request assistance data message, the satellite measurement information for the wireless device is based at least in part on the neighbor cell location. In some embodiments of this aspect, the request assistance data message comprises a list of neighbor cell IDs and a sequence of the neighbor cell IDs in the list being based on a signal strength of each neighbor cell indicated by the respective neighbor cell ID. In some embodiments of this aspect, the processing circuitry is configured to cause the location management network node to select a single neighbor cell ID from the list having a highest signal strength in the list that is also included in a database associated with the location management network node, the satellite measurement information being based at least in part on the selected neighbor cell ID.

In some embodiments of this aspect, the processing circuitry is further configured to cause the location management network node to send a second provide assistance data message comprising a second assistance data; and the request assistance data message comprising the at least one neighbor cell ID is received as a result of the second assistance data being incorrect. In some embodiments of this aspect, the request assistance data message further comprises a primary cell identification, ID, in addition to the at least one neighbor cell ID, the primary cell ID being different from each of the at least one neighbor cell ID. In some embodiments of this aspect, each of the request assistance data message and the provide assistance data message is a Third Generation Partnership Project, 3GPP, Long Term Evolution, LTE, positioning protocol, LPP, message.

In some embodiments of this aspect, the at least one neighbor cell ID is comprised in a common information elements, IEs, request assistance data IE. In some embodiments of this aspect, the request assistance data message comprising the at least one neighbor cell ID is a request for the location management network node to send periodic assistance data to the wireless device. In some embodiments of this aspect, the location management network node includes a location management function, LMF.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to the principles in the present disclosure;

FIG. 2 is a block diagram of a network node in communication with a wireless device over an at least partially wireless connection according to some embodiments of the present disclosure;

FIG. 3 is a flowchart of an example method for a network node according to one embodiment of the present disclosure;

FIG. 4 is a flowchart of an example method for a wireless device according to one embodiment of the present disclosure; and

FIG. 5 is a call flow diagram illustrating an example positioning procedure;

FIG. 6 is a call flow diagram illustrating an example periodic assistance data transfer procedure; and

FIG. 7 is a call flow diagram illustrating an example assistance data transfer procedure according to some embodiments of the present disclosure.

### DETAILED DESCRIPTION

The positioning requests coming from an Access and Mobility Management Function (AMF) or WD generally contain the cell Mobile Country Code-Mobile Network Code-Network Cell Identify (MCC-MNC-NCI) for 5G positionings. The LMF uses the cell information to get the cell location from its own database for preparing the reference data for A-GNSS positioning. However, if the serving cell information cannot be found in the LMF database, the LMF does not have a way to get the cell location and deliver the reference data to the device. Eventually, that will lead to the A-GNSS positioning failure. The reference data generation is to be upon the latitude/longitude which is close to the WD.

In 3GPP Long Term Evolution (LTE) network, if the Evolved Serving Mobile Location Center (E-SMLC) (which may be considered similar to the LMF in 4G) cannot detect the cell information from its database (DB), the E-SMLC would extract the eNodeB Identity/Identification (eNBID) + cell ID from the global cell ID which is attached in the location request. The location request contains the MCC-MNC-Global Cell ID; and the eNBId and cell ID have fixed positions in the Global cell ID. Thus, the E-SMLC is able to find its neighbor cells in the DB by searching the extracted MCC-MNC eNBID, and then prepare and deliver the reference data by using the neighbor cells’ location. The cells under the same eNobeB ID are considered as neighbor cells in the network.

However, neighbor cell searching in the LMF is not possible in this condition. Cells under the same gNodeB Identity/Identification (gNBID) may be considered as neighbor cells. The cell information that is contained in the location request has a format of MCC-MNC-NCI. But the gNBID (5G) does not have fixed positions in the NCI. The NR Cell Identity/Identification (NCI) is a 36 bit integer which includes the gNBID (22-32 bits) and the cell ID. Thus, if only NCI is known at the LMF, it is not possible to extract the gNBID + cell ED to derive the neighbor cell in the LMF DB; unless the gNBID length is known. However, the parameter gNBID length is not required in the location request message.

Currently, existing LMF procedures use a workaround that is very inefficient. The LMF could use a pre-configured default reference location to prepare the reference data and sanity check the final GNSS positioning result. However, in this condition, most of the A-GNSS positionings cannot pass the sanity check finally, because:
1. The reference data based on the pre-configured location is very coarse which may cause the WD to fallback to standalone A-GNSS; and/or
2. It is not possible to map the original cell information MCC-MNC-NCI to the pre-configured location in geography because the location of the cell is unknown. For example, it may be possible that the WD is 20,000 kilometers (km) away from the reference location.

Some embodiments of the present disclosure provide for an update to the periodic assistance data transfer procedure, such as for example, an update to the procedure in Chapter 5.2.1b-Periodic Assistance Data Transfer with Update procedure of 3GPP Technical Specification (TS) 36.355.

Some embodiments of the present disclosure may provide that the 5G A-GNSS positioning success rate can be highly improved when the LMF cannot find the WD’s serving cell in its database, if, for example, the WD can provide the neighbor cell information in the LPP RequestAssisstaceData message.

Some embodiments of the present disclosure may advantageously improve the A-GNSS positioning success rate in the 5G network to assist users in obtaining more accurate positioning results, as compared to some existing arrangements.

Some embodiments of the present disclosure may advantageously avoid positionings fallback to the WD standalone GNSS when the WD cannot retrieve sufficient reference data from the network. WD standalone GNSS may cost significant time and battery usage at the WD to perform the autonomous GPS positionings.

In some embodiments of the present disclosure, the LPP protocol is used for emergency positionings, which may save human lives if this solution becomes the standard.

Some embodiments of the present disclosure may be applicable to any navigation system according to 3GPP, such as GNSS (e.g., GPS, Galileo, GLONASS, etc.) in 3GPP.

In some embodiments, the assistance data described herein may be assistance data that is generated by e.g., an LMF server based on the cell location saved in the LMF database. The assistance data may include the satellites measurements information which can assist the WD to lock the available satellites more rapidly in certain areas. Thus, in some embodiments, the provide assistance data message (e.g., ProvideAssistanceData message), which may be sent by the LMF to the WD, provides assistance data which includes one or more of: a list of satellites measurement that indicates the available satellites’ identifiers (IDs) and measurements (e.g., orbital data, Almanac, coordinated universal time (UTC) model, etc.) for the WD. In some embodiments, such satellite measurement information may allow the WD to bypass the unavailable satellites and only lock and contact those available satellites in the list.

In some embodiments, the provide assistance data message to the WD may serve one or more of the following purposes:
Increase accuracy;
Increase receiver sensitivity, by providing the receiver with small search fields to focus on;
Reduces power consumption, since the receiver only needs to operate during a positioning procedure; and/or
Shortens Time To First Fix (TTFF), by providing the receiver (e.g., WD) with accurate assistance data about which satellites can be found and where to find them.

Some embodiments of the present disclosure may in particular shorten the TTFF by providing the WD with more accurate assistance data about which satellites can be found and where to find them, as compared to existing arrangements.

Before describing in detail exemplary embodiments, it is noted that the embodiments reside primarily in combinations of apparatus components and processing steps related to location based services. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU), Remote Radio Head (RRH), baseband unit (BBU), a core network node (e.g., mobile management entity (MME), self-organizing network (SON) node, a coordinating node, positioning node (e.g., LMF), MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio measurement” used herein may refer to any measurement performed on radio signals. Radio measurements can be absolute or relative. Radio measurement may be called as signal level which may be signal quality and/or signal strength. Radio measurements can be e.g. intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc.

Receiving information may comprise receiving one or more control information messages (e.g., neighbor cell list). It may be considered that receiving signaling comprises demodulating and/or decoding and/or detecting of one or more messages, in particular a message carried by the signaling.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

A cell may be generally a communication cell, e.g., of a cellular or mobile communication network, provided by a node. A serving cell may be a cell on or via which a network node (the node providing or associated to the cell, e.g., base station or eNodeB) transmits and/or may transmit data (which may be data other than broadcast data) to a WD, in particular control and/or user or payload data, and/or via or on which a WD transmits and/or may transmit data to the node; a serving cell may be a cell for or on which the WD is configured and/or to which it is synchronized and/or has performed an access procedure, e.g., a random access procedure, and/or in relation to which it is in a RRC_connected or RRC_idle state, e.g., in case the node and/or user equipment and/or network follow the LTE or NR-standard. One or more carriers (e.g., uplink and/or downlink carrier/s and/or a carrier for both uplink and downlink) may be associated to a cell.

It may be considered for cellular communication there is provided at least one uplink (UL) connection and/or channel and/or carrier and at least one downlink (DL) connection and/or channel and/or carrier, e.g., via and/or defining a cell, which may be provided by a network node, in particular a base station or gNodeB. An uplink direction may refer to a data transfer direction from a terminal to a network node, e.g., base station and/or relay station. A downlink direction may refer to a data transfer direction from a network node, e.g., base station and/or relay node, to a terminal. UL and DL may be associated to different frequency resources, e.g., carriers and/or spectral bands. A cell may comprise at least one uplink carrier and at least one downlink carrier, which may have different frequency bands. A network node, e.g., a base station or gNodeB, may be adapted to provide and/or define and/or control one or more cells.

Predefined in the context of this disclosure may refer to the related information being defined for example in a standard, and/or being available without specific configuration from a network or network node, e.g. stored in memory at a WD, for example independent of being configured. Configured or configurable may be considered to pertain to the corresponding information being set/configured, e.g. by the network or a network node.

In some embodiments, the terms “location server”, “location management node” and “location management network node” may be used herein interchangeably.

Any two or more embodiments described in this disclosure may be combined in any way with each other.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide arrangements for using one or more dynamic machine learning decision thresholds for resource allocation/de-allocation.

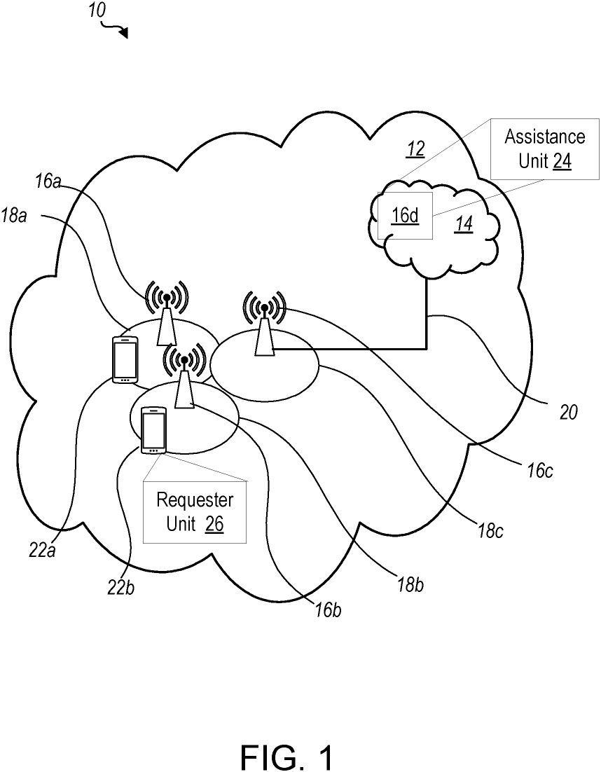

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. One or more network nodes 16c (e.g., LMF) may be part of the core network 14. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 is configured to include an assistance unit 24 which is configured to cause the network node 16 to receive a request assistance data message comprising at least one neighbor cell identification, ID, from a wireless device; and send a provide assistance data message comprising assistance data, the assistance data including satellite measurement information for the wireless device and the satellite measurement information being based at least in part on the at least one neighbor cell ID.

In some embodiments, a WD 22 is configured to include a requester unit 26 which is configured to cause the WD 22 to send a request assistance data message comprising at least one neighbor cell identification, ID, to a location management network node; and receive a provide assistance data message comprising assistance data, the assistance data including satellite measurement information for the wireless device and the satellite measurement information being based at least in part on the at least one neighbor cell ID.

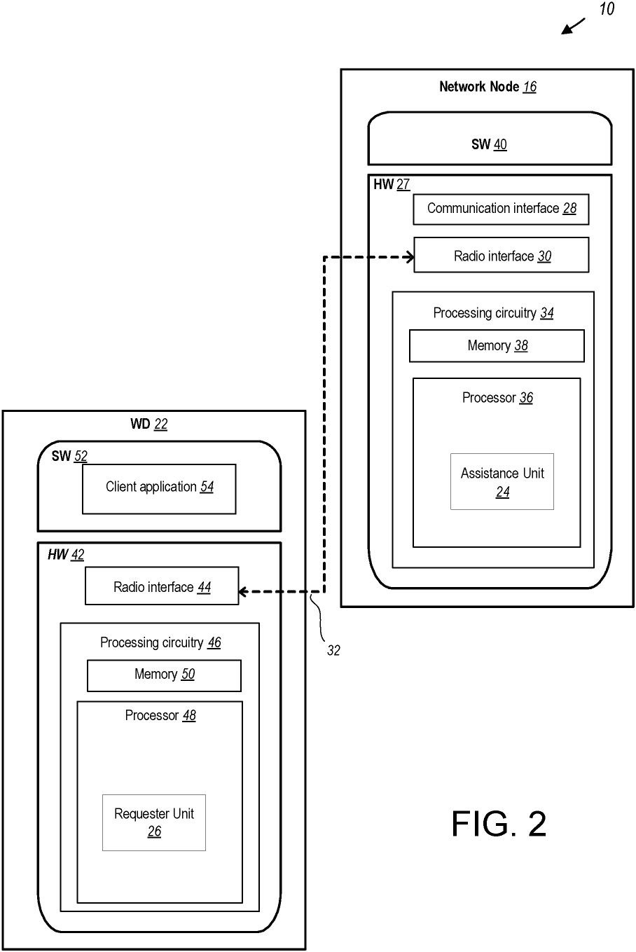

Example implementations, in accordance with an embodiment, of the WD 22 and network node 16 discussed in the preceding paragraphs will now be described with reference to FIG. 2.

The communication system 10 further includes a network node 16 provided in a communication system 10 and including hardware 27 enabling it to communicate with the WD 22. The hardware 27 may include a communication interface 28 for setting up and maintaining a wired or wireless connection with an interface of a different communication device of the communication system 10, as well as a radio interface 30 for setting up and maintaining at least a connection 32, such as a wireless connection, with a WD 22. The radio interface 30 may be formed as or may include, for example, one or more RF transmitters, one or more RF receivers, and/or one or more RF transceivers.

In the embodiment shown, the hardware 27 of the network node 16 further includes processing circuitry 34. The processing circuitry 34 may include a processor 36 and a memory 38. In particular, in addition to or instead of a processor, such as a central processing unit, and memory, the processing circuitry 34 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 36 may be configured to access (e.g., write to and/or read from) the memory 38, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

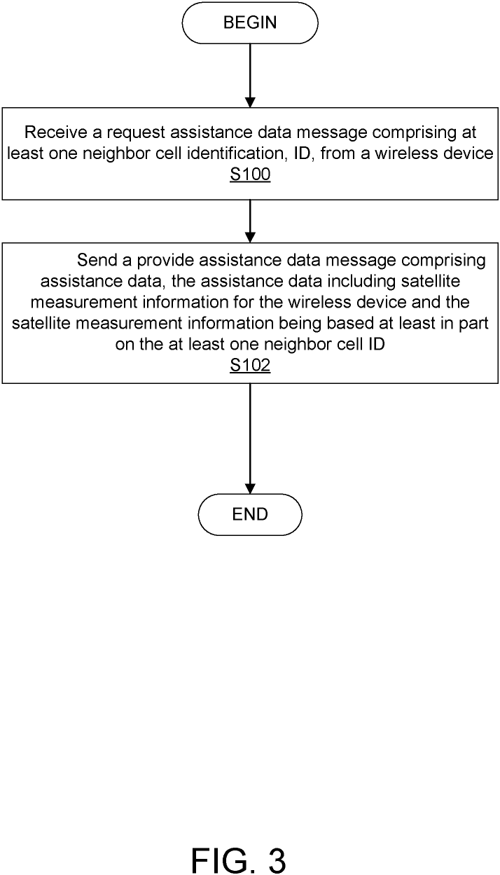

Thus, the network node 16 further has software 40 stored internally in, for example, memory 38, or stored in external memory (e.g., database, storage array, network storage device, etc.) accessible by the network node 16 via an external connection. The software 40 may be executable by the processing circuitry 34. The processing circuitry 34 may be configured to control any of the methods and/or processes described herein and/or to cause such methods, and/or processes to be performed, e.g., by network node 16. Processor 36 corresponds to one or more processors 36 for performing network node 16 functions described herein. The memory 38 is configured to store data, programmatic software code and/or other information described herein. In some embodiments, the software 40 may include instructions that, when executed by the processor 36 and/or processing circuitry 34, causes the processor 36 and/or processing circuitry 34 to perform the processes described herein with respect to network node 16. For example, processing circuitry 34 of the network node 16 may include assistance unit 24 configured to perform network node methods discussed herein, such as the methods discussed with reference to FIG. 3 as well as other figures.

The communication system 10 further includes the WD 22 already referred to. The WD 22 may have hardware 42 that may include a radio interface 44 configured to set up and maintain a wireless connection 32 with a network node 16 serving a coverage area 18 in which the WD 22 is currently located. The radio interface 44 may be formed as or may include, for example, one or more RF transmitters, one or more RF receivers, and/or one or more RF transceivers.

The hardware 42 of the WD 22 further includes processing circuitry 46. The processing circuitry 46 may include a processor 48 and memory 50. In particular, in addition to or instead of a processor, such as a central processing unit, and memory, the processing circuitry 46 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) memory 50, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 52, which is stored in, for example, memory 50 at the WD 22, or stored in external memory (e.g., database, storage array, network storage device, etc.) accessible by the WD 22. The software 52 may be executable by the processing circuitry 46. The software 52 may include a client application 54. The client application 54 may be operable to provide a service to a human or non-human user via the WD 22. The client application 54 may interact with the user to generate the user data that it provides.

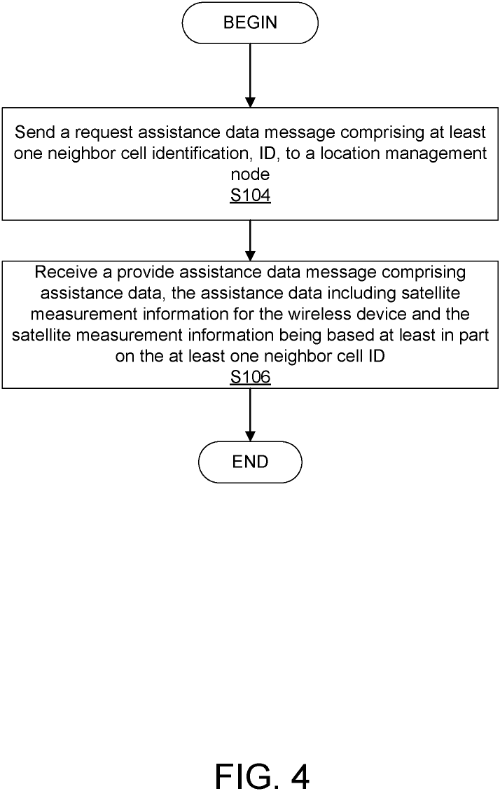

The processing circuitry 46 may be configured to control any of the methods and/or processes described herein and/or to cause such methods, and/or processes to be performed, e.g., by WD 22. The processor 48 corresponds to one or more processors 48 for performing WD 22 functions described herein. The WD 22 includes memory 50 that is configured to store data, programmatic software code and/or other information described herein. In some embodiments, the software 52 and/or the client application 54 may include instructions that, when executed by the processor 48 and/or processing circuitry 46, causes the processor 48 and/or processing circuitry 46 to perform the processes described herein with respect to WD 22. For example, the processing circuitry 46 of the wireless device 22 may be configured to include requester unit 26 configured to perform WD methods discussed herein, such as the methods discussed with reference to FIG. 4 as well as other figures.

In some embodiments, the inner workings of the network node 16 and WD 22, may be as shown in FIG. 2 and independently, the surrounding network topology may be that of FIG. 1.

Although FIGS. 1 and 2 show various “units” such as assistance unit 24 and requester unit 26 as being within a processor, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart of an exemplary process in a network node 16 for allocating resources using a dynamic decision threshold according to some embodiments of the present disclosure. One or more Blocks and/or functions and/or methods performed by the network node 16 may be performed by one or more elements of network node 16 such as by assistance unit 24 in processing circuitry 34, processor 36, communication interface 28, radio interface 30, etc. according to the example method. The example method includes receiving (Block S100), such as via assistance unit 24, processing circuitry 34, processor 36, communication interface 28 and/or radio interface 30, a request assistance data message comprising at least one neighbor cell identification, ID, from a wireless device 22. The method includes sending (Block S102), such as via assistance unit 24, processing circuitry 34, processor 36, communication interface 28 and/or radio interface 30, a provide assistance data message comprising assistance data, the assistance data including satellite measurement information for the wireless device and the satellite measurement information being based at least in part on the at least one neighbor cell ID.

In some embodiments, the method includes determining, such as via assistance unit 24, processing circuitry 34, processor 36, communication interface 28 and/or radio interface 30, a neighbor cell location using the at least one neighbor cell ID comprised in the request assistance data message; and the satellite measurement information for the wireless device 22 is based at least in part on the neighbor cell location. In some embodiments, the request assistance data message comprises a list of neighbor cell IDs and a sequence of the neighbor cell IDs in the list being based on a signal strength of each neighbor cell indicated by the respective neighbor cell ID.

In some embodiments, the method includes selecting, such as via assistance unit 24, processing circuitry 34, processor 36, communication interface 28 and/or radio interface 30, a single neighbor cell ID from the list having a highest signal strength in the list that is also included in a database associated with the location management network node 16; and the satellite measurement information is based at least in part on the selected neighbor cell ID. In some embodiments, the method includes sending, such as via assistance unit 24, processing circuitry 34, processor 36, communication interface 28 and/or radio interface 30, a second provide assistance data message comprising a second assistance data; and receiving, such as via assistance unit 24, processing circuitry 34, processor 36, communication interface 28 and/or radio interface 30, the request assistance data message comprising the at least one neighbor cell ID is a result of the second assistance data being incorrect.

In some embodiments, the request assistance data message further comprises a primary cell identification, ID, in addition to the at least one neighbor cell ID, the primary cell ID being different from each of the at least one neighbor cell ID. In some embodiments, each of the request assistance data message and the provide assistance data message is a Third Generation Partnership Project, 3GPP, Long Term Evolution, LTE, positioning protocol, LPP, message. In some embodiments, the at least one neighbor cell ID is comprised in a common information elements, IEs, request assistance data IE. In some embodiments, the request assistance data message comprising the at least one neighbor cell ID is a request for the location management network node 16 to send periodic assistance data to the wireless device 22. In some embodiments, the location management network node 16 includes a location management function, LMF.

FIG. 4 is a flowchart of an exemplary process in a wireless device 22 for network node 16 for de-allocating resources using a dynamic decision threshold according to some embodiments of the present disclosure. One or more Blocks and/or functions and/or methods performed by WD 22 may be performed by one or more elements of WD 22 such as by requester unit 26 in processing circuitry 46, processor 48, communication interface 28, radio interface 44, etc. The example method includes sending (Block S104), such as via requester unit 26, processing circuitry 46, processor 48, communication interface 28, and/or radio interface 44, a request assistance data message comprising at least one neighbor cell identification, ID, to a location management network node 16. The method includes receiving (Block S106), such as via requester unit 26, processing circuitry 46, processor 48, communication interface 28, and/or radio interface 44, a provide assistance data message comprising assistance data, the assistance data including satellite measurement information for the wireless device and the satellite measurement information being based at least in part on the at least one neighbor cell ID.

In some embodiments, the satellite measurement information for the wireless device 22 that is based at least in part on a neighbor cell location, the neighbor cell location being determined using the at least one neighbor cell ID comprised in the request assistance data message. In some embodiments, the request assistance data message comprises a list of neighbor cell IDs, and a sequence of the neighbor cell IDs in the list being determined by a signal strength of each neighbor cell indicated by the respective neighbor cell ID. In some embodiments, the satellite measurement information is based at least in part on a selection of a single neighbor cell ID from the list having a highest signal strength in the list that is also included in a database associated with the location management network node 16.

In some embodiments, the method includes receiving, such as via requester unit 26, processing circuitry 46, processor 48, communication interface 28, and/or radio interface 44, a second provide assistance data message comprising a second assistance data; and determining that the second assistance data is incorrect. In some embodiments, sending, such as via requester unit 26, processing circuitry 46, processor 48, communication interface 28, and/or radio interface 44, the request assistance data message comprising the at least one neighbor cell ID is a result of the determination that the second assistance data is incorrect. In some embodiments, the request assistance data message further comprises a primary cell identification, ID, in addition the at least one neighbor cell ID, the primary cell ID being different from each of the at least one neighbor cell ID.

In some embodiments, each of the request assistance data message and the provide assistance data message is a Third Generation Partnership Project, 3GPP, Long Term Evolution, LTE, positioning protocol, LPP, message. In some embodiments, the at least one neighbor cell ID is comprised in a common information elements, IEs, request assistance data IE. In some embodiments, the request assistance data message comprising the at least one neighbor cell ID is a request for the location management network node 16 to send periodic assistance data to the wireless device 22. In some embodiments, the location management network node includes a location management function, LMF.

Having described the general process flow of arrangements of the disclosure and having provided examples of hardware and software arrangements for implementing the processes and functions of the disclosure, the sections below provide details and examples of arrangements for location based services, which may be implemented by the network node 16 and/or wireless device 22.

Some embodiments provide arrangements related to improving the 3GPP LPP protocol. The overall 5G positioning protocol may be considered for inclusion in 3GPP TS 23.273 5G system location services (LCS) protocol. The specific message between the LMF and the WD 22 may also be considered for inclusion in the 3GPP TS 36.355 LPP protocol.

Some embodiments of the present disclosure may include one or more of the following:

1. If the MCC-MNC-NCI cannot be found in the network node 16 (e.g., LMF) database, the network node 16 (e.g., LMF) applies a default gNB identity/identification (gNBID) length 32 bits to extract the gNBID from the NCI. If the extracted gNBID can be found in the DB, the network node 16 (e.g., LMF) selects those cells as the neighbor cells and generates the assistance data. If the gNBID cannot not be found in the DB, the network node 16 (e.g., LMF) uses the pre-configured Location to generate the assistance data.

2. The network node 16 (e.g., LMF) delivers the “fake” reference data to the WD 22 that was generated in step 1 above.

For purposes of comparing existing behavior to the updated procedure proposed by some embodiments of the present disclosure, an example of the current LPP protocol behavior is:

3a. The WD 22, for example via processing circuitry 46 and/or processor 48 and/or requester unit 26, verifies the assistance data. If the WD 22, for example via processing circuitry 46 and/or processor 48 and/or requester unit 26, considers the reference data is not correct or not sufficient, the WD 22 will send an LPP RquestAssistanceData message to the network node 16 (e.g., LMF) to request more assistance data, which is referring to the current LPP standard. In the current LPP protocol implementation, only when the target device (e.g., WD 22) changes its primary cell and if the update capabilities of the target device (e.g., WD 22) supported by the location server/location management node (e.g., LMF) in step 1 include an update of a primary cell ID, the target device (e.g., WD 22) sends a RequestAssistanceData message to the location server/location management node (e.g., LMF) using some available transaction identity (ID) T3, which is different from transaction ID T2 (previously used in step 2). The message includes the periodicSessionID S (previously used in step 1) and the new primary cell ID in the Information Element (IE) CommonIEsRequestAssistanceData. Chapter 5.2.1b, 3GPP TS 36.355, version (V) 15.5.0 LPP protocol.

In contrast, in some embodiments of the present disclosure, an updated LPP message includes a new step 3, referred to as 3b, which may replace the step 3a above and may include, for example:

3b. Besides the conditions in described in step 3, if the WD 22, for example via processing circuitry 46 and/or processor 48 and/or requester unit 26, detects that the assistance data is not correct or accurate, the WD 22 sends a RequestAssistanceData message to the network node 16 (e.g., LMF) to request more assistance data. The message contains the periodicSessionID S (previously used in step 1), the primary cell ID and neighbor cell IDs in the IE CommonIEsRequestAssistanceData. In some embodiments, the neighbor cell IDs are represented in a list of neighbor cell IDs, where e.g., a characteristic of the list, such as, a sequence/order of the neighbor cell IDs in the list is determined by e.g., the signal strength associated with the cell.

Based on the new step 3b, if the network node 16 (e.g., LMF) receives the RequestAssistanceData + neighbor cell IDs from the WD 22:

4. The network node 16 (e.g., LMF) generates, for example via processing circuitry 34 and/or processor 36 and/or assistance unit 24, the reference data by selecting a cell from the neighbor cell list, such as, for example selecting the cell with the strongest signal strength in the neighbor cell list. Selection by the network node 16 (e.g., LMF) may fall back to the next cell in the list if, for example, the current cell is not found in the LMF database.

5. The network node 16 (e.g., LMF) delivers the assistance data to the WD 22 and A-GNSS positioning may continue.

In some embodiments, neighbor cell IDs may be defined according to e.g.,:

CommonIEsRequestAssistanceData ::= SEQUENCE
{ primaryCellID ECGI OPTIONAL, -- Cond EUTRA ...,
[[ segmentationInfo-r14 SegmentationInfo-r14 OPTIONAL -- Cond
Segmentation
]],
[[ periodicAssistanceDataReq-r15
PeriodicAssistanceDataControlParameters-r15
OPTIONAL, -- Cond PerADreq
primaryCellID-r15 NCGI-r15 OPTIONAL -- Cond NR
neighbourCellID-r15 NCGI-r15 OPTIONAL -- Cond NR
neighbourCellID-r15 NCGI-r15 OPTIONAL -- Cond NR
...
]] }

The bolded parts above may be considered an example of the update to the CommonIEsRequestAssistanceData IE according to some embodiments.

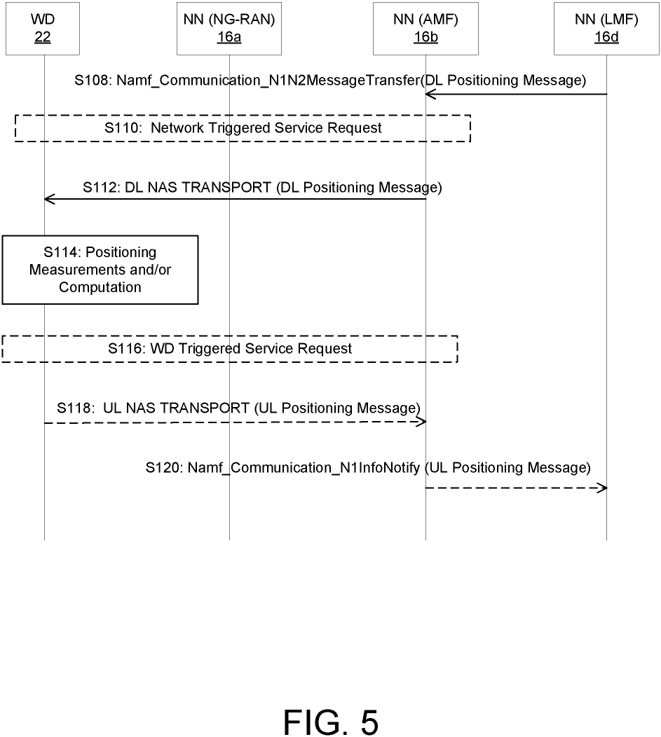

FIG. 5 illustrates an example positioning procedure, similar to a positioning procedure in Chapter 6.11.1 of 3GPP TS 23.273, version 16.3.

In some embodiments, a precondition assumed for FIG. 5 may include that a LCS Correlation identifier and the AMF identity has been passed to the network node 16d (e.g., LMF) by the serving AMF (e.g., network node (NN) 16b). FIG. 5 shows the following steps:

S108: The network node 16d (e.g., LMF) invokes the Namf_Communication_N1N2MessageTransfer service operation towards the AMF (e.g., network node (NN) 16b) to request the transfer of a Downlink (DL) Positioning message to the WD 22. The service operation includes the DL Positioning message. The Session ID parameter of the Namf_Communication_N1N2MessageTransfer service operation is set to the LCS Correlation identifier. The Downlink Positioning message may request location information from the WD 22, provide assistance data to the WD 22 or query for the WD 22 capabilities. In some embodiments, the Namf_Communication_N1N2MessageTransfer service operation may be used by the network node 16d (e.g., LMF) to send the information described herein to the WD 22, such as, the provide assistance data message comprising the assistance data including the satellite measurement information.

S110: If the WD 22 is in Connected Mode (CM) IDLE state, the AMF (e.g., network node (NN) 16b) initiates a network triggered Service Request procedure as defined in e.g., clause 4.2.3.3 of TS 23.502 to establish a signalling connection with the WD 22.

S112: The AMF (e.g., network node (NN) 16b) forwards the Downlink Positioning message to the WD 22 in a DL NAS TRANSPORT message. The AMF (e.g., network node (NN) 16b) includes a Routing identifier, in the DL NAS TRANSPORT message, which is set to the LCS Correlation identifier. The Downlink Positioning message may request the WD 22 to respond to the network, e.g. may request the WD 22 to acknowledge the Downlink Positioning message, to return location information or to return capabilities, as defined in e.g., 3GPP TS 36.355.

S114: The WD 22 stores any assistance data provided in the Downlink Positioning message and performs any positioning measurements and/or location computation requested by the Downlink Positioning message.

S116: If the WD 22 has entered CM-IDLE state during step S114 and needs to respond to the request received in step S112, the WD 22 instigates the WD 22 triggered Service Request as defined in Clause 4.2.3.2 of 3GPP TS 23.502 in order to establish a signalling connection with the AMF (e.g., network node (NN) 16b).

S118: [Conditional] The WD 22 sends to the AMF (e.g., network node (NN) 16b) the Uplink (UL) Positioning message included in a NAS TRANSPORT message, e.g. to acknowledge the Downlink Positioning message, to return any location information obtained in step S114 or returns any capabilities, as requested in step S112. When the WD 22 sends the Uplink Positioning message in a NAS TRANSPORT message, the WD 22 may also include in the UL NAS TRANSPORT message the Routing identifier received in step S112.

S120: [Conditional] The AMF (e.g., network node (NN) 16b) invokes the Namf Communication NlMessageNotify service operation towards the network node 16 (e.g., LMF) indicated by the routing identifier received in step S118. The service operation includes the Uplink Positioning message received in step S118 and the LCS Correlation identifier. Steps S118 and S120 may be repeated if the WD 22 sends multiple Uplink Positioning messages to respond to the request received in Step S112. Steps S108 to S120 may be repeated to send new assistance data, and to request further location information and further WD 22 capabilities.

In some embodiments, the Uplink Positioning message in step S118 and/or the Namf_Communication_N1MessageNotify service operation in step S120 may be used by the WD 22 and AMF respectively, to transport/send the neighbor cell ID list and/or corresponding signal strength information disclosed herein to the network node 16d (e.g., LMF). Then the network node 16d (e.g., LMF) may use such information to prepare the satellites list/satellite measurement information for the WD 22 based on the neighbor cell list. The network node 16d (e.g., LMF) may then deliver the new assistance data toward the WD 22, such as, for example, via the Namf_Communication_N1N2MessageTransfer service operation.

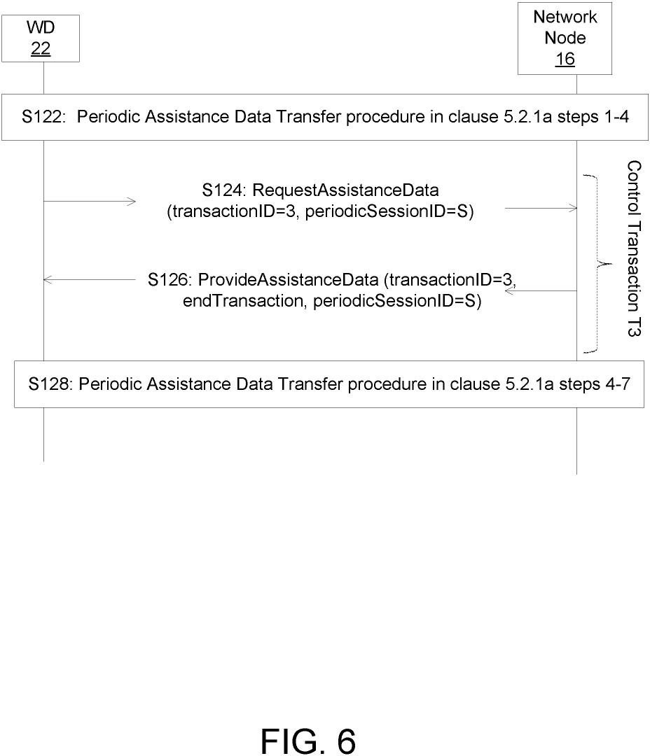

FIG. 6 illustrates an example periodic assistance data transfer procedure which may be updated according to some embodiments. The example method may include one or more of the following:

S122: One or more steps for a Periodic Assistance Data Transfer procedure may be performed. For example, steps 1-2 and optionally steps 3-4 of clause 5.2.1a, 3GPP TS 36.355 v15.5.0, may be performed for the Periodic Assistance Data Transfer procedure with the following updates:
The RequestAssistanceData message in step 1 of clause 5.2.1a indicates the update capabilities of the target device (e.g., WD 22).
The ProvideAssistanceData message in step 2 of clause 5.2.1a indicates the update capabilities of the target device (e.g., WD 22) which are supported by the location server/location management node (e.g., network node 16d, such as LMF).

S124: If the target WD 22 changes its primary cell and if the update capabilities of the target WD 22 supported by the location server (e.g., network node 16d) in step 1 of clause 5.2.1a include the update of a primary cell ID, or if the WD 22 detects the assistance data is not correct or accurate, the target WD 22 sends a RequestAssistanceData message to the location server (e.g., network node 16d, such as LMF). The RequestAssistanceData message may use an available transaction ID T3, which is different from the transaction ID T2 (previously used in step 1 of clause 5.2.1a). The message may include the periodicSessionID S, the new primary cell ID and the neighbor cell IDs in the IE CommonIEsRequestAssistanceData.

S126: The location server (e.g., network node 16d) responds with a ProvideAssistanceData message to the target WD 22. The message uses the transactionID T3 in step S124 and indicates the end of this transaction. The message includes the periodicSessionID S in IE CommonIEsProvideAssistanceData. Steps S124 and S126 may be repeated each time the target WD 22 changes its primary cell.

S128: One or more steps for a Periodic Assistance Data Transfer procedure may be performed, such as, for example, steps 4-7 as in clause 5.2.1a.

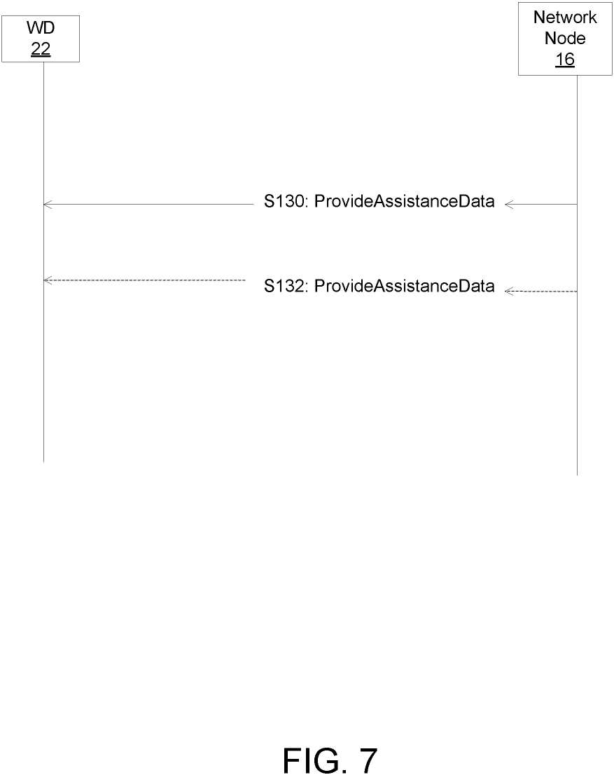

FIG. 7 illustrates an example LPP Assistance Data transfer procedure (e.g., 3GPP TS 36.355, version 15.5.0) which may be updated according to some embodiments of the present disclosure. The example procedure may include one or more of the following steps:

S130: The location server (e.g., network node 16d) sends a ProvideAssistanceData message to the target WD 22 including assistance data. In some embodiments, such assistance data may be based on one or more the neighbor cell IDs in the IE CommonIEsRequestAssistanceData, such as a neighbor cell ID selected by network node 16d according to the techniques disclosed herein. If step S132 does not occur, this message sets the endTransaction IE to TRUE.

S132: The location server (e.g., network node 16d) may transmit one or more additional ProvideAssistanceData messages to the target WD 22 including additional assistance data. In some embodiments, such assistance data may be based on one or more the neighbor cell IDs in the IE CommonIEsRequestAssistanceData, such as a neighbor cell ID selected by network node 16d according to the techniques disclosed herein. The last message may include the endTransaction IE set to TRUE.

Some embodiments of the present disclosure may provide an update to the LPP protocol which may be useful for emergency positionings. Some embodiments may avoid positioning fall back to a WD standalone GNSS positioning mode, particularly when the WD 22 cannot obtain sufficient reference data from the network, which may reduce costs associated with significant battery usage at the WD from performing the standalone GPS positionings.

One or more of the following abbreviations may be used in the present disclosure:

| | |
|---|---|
| Abbreviation | Explanation |
| A-GNSS | Assisted Global Navigation Satellite System |
| LMF | Location Management Function |
| NCI | NR cell identity |
| UE | User Equipment |

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user’s computer, partly on the user’s computer, as a stand-alone software package, partly on the user’s computer and partly on a remote computer or entirely on the remote computer. In the latter scenario, the remote computer may be connected to the user’s computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A method implemented in a wireless device, WD, the method comprising:
sending a request assistance data message comprising at least one neighbor cell identification, ID, to a location management network node; and
receiving a provide assistance data message comprising assistance data, the assistance data including satellite measurement information for the wireless device and the satellite measurement information being based at least in part on the at least one neighbor cell ID.

2. The method of claim 1, wherein the satellite measurement information is based at least in part on a neighbor cell location, the neighbor cell location being determined using the at least one neighbor cell ID comprised in the request assistance data message.

3. The method of claim 1, wherein the request assistance data message comprises a list of neighbor cell IDs, and a sequence of the neighbor cell IDs in the list being determined by a signal strength of each neighbor cell indicated by the respective neighbor cell ID.

4. The method of claim 3, wherein the satellite measurement information is based at least in part on a selection of a single neighbor cell ID from the list having a highest signal strength in the list that is also included in a database associated with the location management network node.

5. The method of claim 1, further comprising:
receiving a second provide assistance data message comprising a second assistance data; and
determining that the second assistance data is incorrect; and
wherein sending the request assistance data message comprising the at least one neighbor cell ID is a result of the determination that the second assistance data is incorrect.

6. The method of claim 1, wherein the request assistance data message further comprises a primary cell identification, ID, in addition the at least one neighbor cell ID, the primary cell ID being different from each of the at least one neighbor cell ID.

7. The method of claim 1, wherein each of the request assistance data message and the provide assistance data message is a Third Generation Partnership Project, 3GPP, Long Term Evolution, LTE, positioning protocol, LPP, message.

8. The method of claim 1, wherein the at least one neighbor cell ID is comprised in a common information elements, IEs, request assistance data IE.

9. The method of claim 1, wherein the request assistance data message comprising the at least one neighbor cell ID is a request for the location management network node to send periodic assistance data to the wireless device .

10. The method of claim 1, wherein the location management network node includes a location management function, LMF.

11. A method implemented in a location management network node, the method comprising:
receiving a request assistance data message comprising at least one neighbor cell identification, ID, from a wireless device; and
sending a provide assistance data message comprising assistance data, the assistance data including satellite measurement information for the wireless device and the satellite measurement information being based at least in part on the at least one neighbor cell ID.

12. The method of claim 11, further comprising:
determining a neighbor cell location using the at least one neighbor cell ID comprised in the request assistance data message; and
wherein the satellite measurement information is based at least in part on the neighbor cell location.

13. The method of claim 11, wherein the request assistance data message comprises a list of neighbor cell IDs and a sequence of the neighbor cell IDs in the list being based on a signal strength of each neighbor cell indicated by the respective neighbor cell ID.

14. The method of claim 13, further comprising:
selecting a single neighbor cell ID from the list having a highest signal strength in the list that is also included in a database associated with the location management network node; and
wherein the satellite measurement information is based at least in part on the selected neighbor cell ID.

15. The method of claim 11, further comprising:
sending a second provide assistance data message comprising a second assistance data; and
wherein receiving the request assistance data message comprising the at least one neighbor cell ID is a result of the second assistance data being incorrect.

16. The method of claim 11, wherein the request assistance data message further comprises a primary cell identification, ID, in addition to the at least one neighbor cell ID, the primary cell ID being different from each of the at least one neighbor cell ID.

17. The method of claim 11, wherein each of the request assistance data message and the provide assistance data message is a Third Generation Partnership Project, 3GPP, Long Term Evolution, LTE, positioning protocol, LPP, message.

18. The method of claim 11, wherein the at least one neighbor cell ID is comprised in a common information elements, IEs, request assistance data IE.

19. The method of claim 11, wherein the request assistance data message comprising the at least one neighbor cell ID is a request for the location management network node to send periodic assistance data to the wireless device.

20. The method of claim 11, wherein the location management network node includes a location management function, LMF.

21-40. (canceled)
